(19) United States
(12) Patent Application Publication
(10) Pub. No.: US 2025/0346188 A1
(43) Pub. Date: Nov. 13, 2025

(54) SEMI-AUTOMATIC PEDAL

(71) Applicant: WINBO-DONGJIAN AUTOMOTIVE TECHNOLOGY CO., LTD., Foshan (CN)

(72) Inventors: Guowei LIN, Foshan (CN); Jie YANG, Foshan (CN); Zhigang WAN, Foshan (CN); Weiting HE, Foshan (CN)

(73) Assignee: WINBO-DONGJIAN AUTOMOTIVE TECHNOLOGY CO., LTD., Foshan (CN)

(21) Appl. No.: 18/868,799

(22) PCT Filed: Oct. 20, 2023
(86) PCT No.: PCT/CN2023/125638

§ 371 Date: Nov. 25, 2024

(30) Foreign Application Priority Data
Apr. 27, 2023 (CN) 202310477760.0

(51) Int. Cl. B60R 3/02

(52) U.S. Cl. CPC B60R 3/02

(57) ABSTRACT

A semi-automatic pedal includes a fixed base including first and second fixed plates; a pedal; and a transmission assembly. The second fixed plate, provided with a limiting passage, has an upper end connected to the first fixed plate; the first fixed plate is rotationally connected to upper ends of an elastic driving member and a first transmission arm by first and second rotating shafts respectively; the first transmission arm has an upper end rotationally connected to a lower end of the elastic driving member by a third rotating shaft, and a lower end rotationally connected to an upper end of a second transmission arm by a fourth rotating shaft; the second transmission arm, provided with a track limiting groove provided slidably with the sliding member therein, is connected to the pedal at a lower end thereof, and to a lower end of the second fixed plate by a sliding member.

### CROSS-REFERENCE TO RELATED APPLICATION

The present disclosure claims the priority to the Chinese patent application with the filing No. 202310477760.0, filed on Apr. 27, 2023 with the Chinese Patent Office and entitled “SEMI-AUTOMATIC PEDAL”, the contents of which are incorporated herein by reference in entirety.

### TECHNICAL FIELD

The present disclosure relates to the technical field of vehicle accessories, and in particularly to a semi-automatic pedal.

### BACKGROUND ART

At present, pickup trucks or trucks on the market all have a high vehicle body, and it is inconvenient for some people, who want to enter a trunk or a cargo hold of a pickup truck, to enter the trunk through a tailgate plate even if the tailgate plate can be turned over. In addition, for some retrofit or customized products on the market, retrofitting costs are also high, and original factory bumper needs to be removed for many products, which will cause some refitting concerns to users.

### SUMMARY

The present disclosure is intended to at least solving one of the technical problems existing in the prior art. The present disclosure provides a semi-automatic pedal, which can effectively improve comfort for people to enter a trunk or a cargo hold of a pickup truck, and can be directly mounted and connected to an original vehicle, thus reducing retrofitting costs, and avoiding great influence on trafficability of automobiles.

In order to achieve the above objective, the present disclosure provides a semi-automatic pedal, including a fixed seat configured to be connected to a vehicle body, a pedal and a transmission assembly. The transmission assembly includes an elastic driving member, a first transmission arm, a sliding member and a second transmission arm. The fixed seat includes a first fixed plate and a second fixed plate. An upper end of the second fixed plate is connected to the first fixed plate. The second fixed plate is provided with a limiting passage with an opening facing downwards. At least a part of the second transmission arm passes through the limiting passage. The first fixed plate is rotatably connected to an upper end of the elastic driving member through a first rotating shaft. The first fixed plate is rotatably connected to an upper end of the first transmission arm through a second rotating shaft. The upper end of the first transmission arm is rotatably connected to a lower end of the elastic driving member through a third rotating shaft. A lower end of the first transmission arm is rotatably connected to an upper end of the second transmission arm through a fourth rotating shaft. A lower end of the second transmission arm is connected to the pedal. The second transmission arm is connected to a lower end of the second fixed plate through the sliding member. The second transmission arm is provided with a track limiting groove. The sliding member is slidably mounted in the track limiting groove. The first rotating shaft, the second rotating shaft, the third rotating shaft, and the fourth rotating shaft are provided in the same direction.

As a preferred solution, when the sliding member is located at the lower end of the second transmission arm, a distance between the lower end of the second transmission arm and the first fixed plate is a, a distance between the lower end of the second transmission arm and the second fixed plate is b; and when the sliding member is located at the upper end of the second transmission arm, a distance between the lower end of the second transmission arm and the first fixed plate is c, and a distance between the lower end of the second transmission arm and the second fixed plate is d, where a is less than c, and b is less than d.

As a preferred solution, the sliding member includes a sliding base, a roller and a fifth rotating shaft, where the roller is rotatably mounted on the sliding base, the sliding base is connected to the lower end of the second fixed plate through the fifth rotating shaft, and the roller is rotatably mounted in the track limiting groove.

As a preferred solution, a side wall of the track limiting groove is provided with a limiting side groove, the sliding member includes a roller shaft, the roller is rotationally mounted on the sliding base through the roller shaft, and the roller shaft is slidably mounted in the limiting side groove.

As a preferred solution, one side of the first transmission arm facing the first fixed plate is connected with a first cushion pad, and the second fixed plate is provided with a second cushion pad and a third cushion pad, where the second cushion pad is located at the lower end of the second fixed plate and faces one side of the first transmission arm, and the third cushion pad is mounted in the limiting passage and located above the second transmission arm; and

the transmission assembly has a folded state and an unfolded state, where when the transmission assembly is in the folded state, the upper end of the first transmission arm abuts against the first fixed plate through the first cushion pad, and the third cushion pad abuts against the second transmission arm; and when the transmission assembly is in the unfolded state, the lower end of the first transmission arm abuts against the lower end of the second fixed plate through the second cushion pad.

As a preferred solution, the second transmission arm includes a curved arm and a connecting plate, where the curved arm is provided with the track limiting groove having an opening facing downwards, a groove bottom surface of the track limiting groove at least includes a curved surface, the connecting plate is connected to a lower end of the curved arm, the connecting plate is connected to the pedal, and the pedal is located at one side of the second fixed plate away from the first transmission arm.

As a preferred solution, when the transmission assembly is in the folded state, one end of the connecting plate is connected to the lower end of the curved arm, and the other end of the connecting plate is tilted upwards.

As a preferred solution, the connecting plate is provided with a first connecting groove extending in a first direction, a side of the pedal facing the connecting plate is provided with a second connecting groove extending in a second direction, and the connecting plate is connected to the pedal by a connecting member passing through the first connecting groove and the second connecting groove, where the first direction intersects with the second direction.

As a preferred solution, the elastic driving member includes an elastic member and cover plates, two ends of the elastic member are respectively connected to the cover plates, the cover plates are each provided with a cover shaft hole, the first rotating shaft is connected to the first fixed plate through the cover shaft hole located at the upper end of the elastic driving member, and the third rotating shaft is connected to the upper end of the first transmission arm through the cover shaft hole located at the lower end of the elastic driving member.

As a preferred solution, the lower end of the first transmission arm is provided with an avoidance cavity having an opening facing the second transmission arm, the lower end of the first transmission arm is provided with a connecting hole, the connecting hole communicates with the avoidance cavity, the upper end of the second transmission arm is mounted in the avoidance cavity, and the fourth rotating shaft is mounted in the connecting hole.

Compared with the prior art, the semi-automatic pedal provided in the embodiments of the present disclosure has beneficial effects as follows. The fixed seat is configured to be connected to a bottom portion of the vehicle body and fix the transmission assembly. The pedal is configured to help people to get in and out of the vehicle. The fixed seat includes the first fixed plate and the second fixed plate, where the upper end of the second fixed plate is connected to the first fixed plate, and the lower end of the second fixed plate extends downwards. The pedal is located at one side of the second fixed plate away from the first fixed plate. An accommodation cavity is provided at sides, away from the pedal, of the first fixed plate and the second fixed plate. When the transmission assembly is in the folded state, the transmission assembly is located in the accommodation cavity. In the above, the transmission assembly includes the elastic driving member, the first transmission arm, the sliding member and the second transmission arm, where the elastic driving member provides a transmission driving force for the transmission assembly. Specifically, the upper end of the elastic driving member is connected to the first fixed plate through the first rotating shaft, and the upper end of the elastic driving member rotates relative to the first fixed plate; the upper end of the first transmission arm is connected to the first fixed plate through the second rotating shaft, and the upper end of the first transmission arm can rotate relative to the first fixed plate; the upper end of the first transmission arm is connected to the lower end of the elastic driving member through the third rotating shaft, and the upper end of the first transmission arm can rotate relative to the lower end of the elastic driving member; and the lower end of the first transmission arm is rotatably connected to the upper end of the second transmission arm through the fourth rotating shaft, and the lower end of the first transmission arm can rotate relative to the upper end of the second transmission arm. Meanwhile, the first rotating shaft, the second rotating shaft, the third rotating shaft, and the fourth rotating shaft are provided in the same direction. The second transmission arm is connected to the second fixed plate through the sliding member, where the second fixed plate is provided with the limiting passage, the second transmission arm is connected to the pedal through the limiting passage, and the second transmission arm is retracted or extends out through the limiting passage, so as to realize the folded or unfolded state. The second transmission arm is provided with the track limiting groove, and the sliding member is slidably mounted in the track limiting groove. By applying a downward or upward force to the pedal, the sliding member is enabled to slide relatively in the track limiting groove, so as to realize that the second transmission arm drives the pedal to move away from or close to the second fixed plate, and the pedal extends out to form the unfolded state or is retracted to form the folded state. When people need to get in or out of the vehicle, a downward force is applied to the pedal, and the second transmission arm drives the pedal to move downwards away from the second fixed plate, so that the pedal is lowered to a suitable height and facilitates people in getting in or out of the vehicle, thus effectively improving the comfort for people to enter a trunk or cargo hold of a pickup truck. When the pedal does not need to be used, an upward force is applied to the pedal, the second transmission arm extends into the accommodation cavity, and the pedal moves upwards towards the second fixed plate, so that the second transmission arm is hidden in the vehicle body, thus reducing or avoiding the pedal from protruding out from the vehicle body to affect trafficability of the vehicle. At the same time, the pedal only needs to be mounted to an edge of the bottom portion of the vehicle body through the fixed seat, and can be directly mounted and connected to an original vehicle, thus reducing retrofitting costs.

### BRIEF DESCRIPTION OF DRAWINGS

In order to more clearly illustrate technical solutions of embodiments of the present disclosure, drawings which need to be used in the embodiments will be briefly introduced below, and it should be understood that the drawings merely show some embodiments of the present disclosure, but should not be thus construed as limitation to the scope. Those ordinarily skilled in the art still could obtain other relevant drawings according to these drawings without using any inventive efforts.

FIG. 1 is an overall structural schematic view of embodiments of the present disclosure;

FIG. 2 is a schematic view of a whole structure of embodiments of the present disclosure with components being separated;

FIG. 3 is a structural schematic view of a transmission assembly and a pedal according to embodiments of the present disclosure;

FIG. 4 is a structural schematic view of a sliding member according to embodiments of the present disclosure;

FIG. 5 is a side structural schematic view in a folded state according to embodiments of the present disclosure;

FIG. 6 is a front structural schematic view in a folded state according to embodiments of the present disclosure;

FIG. 7 is a sectional structural schematic view taken along A-A in FIG. 6 according to embodiments of the present disclosure;

FIG. 8 is a front structural schematic view in a folded state and a balanced state according to embodiments of the present disclosure;

FIG. 9 is a sectional structural schematic view taken along A-A in FIG. 8 according to embodiments of the present disclosure;

FIG. 10 is a sectional structural schematic view taken along B-B in FIG. 8 according to embodiments of the present disclosure;

FIG. 11 is a front structural schematic view in a balanced state according to embodiments of the present disclosure;

FIG. 12 is a sectional structural schematic view taken along A-A in FIG. 11 according to embodiments of the present disclosure;

FIG. 13 is a sectional structural schematic view taken along B-B in FIG. 11 according to embodiments of the present disclosure;

FIG. 14 is a front structural schematic view in an unfolded state according to embodiments of the present disclosure;

FIG. 15 is a sectional structural schematic view taken along A-A in FIG. 14 according to embodiments of the present disclosure;

FIG. 16 is a sectional structural schematic view taken along B-B in FIG. 14 according to embodiments of the present disclosure;

FIG. 17 is a structural schematic view showing mounting of a rotating shaft assembly according to embodiments of the present disclosure;

FIG. 18 is a structural schematic view of a semi-automatic pedal mounted to a vehicle body according to embodiments of the present disclosure; and

FIG. 19 is a view of movement track of a pedal when a groove bottom surface of a track limiting groove of a curved arm is a curved surface in the present disclosure.

### DESCRIPTION OF REFERENCE SIGNS OF MAIN ELEMENTS

10. fixed seat; 11. first fixed plate; 12. second fixed plate; 13. second cushion pad; 14. third cushion pad; 15. limiting passage; 16. pedal; 17. second connecting groove; 18. transmission assembly;
20. first transmission arm; 21. first cushion pad; 22. avoidance cavity; 23. connecting hole;
30. elastic driving member; 31. elastic member; 32. cover plate; 33. cover shaft hole;
40. sliding member; 41. sliding base; 42. roller; 43. fifth rotating shaft; 44. roller shaft;
50. second transmission arm; 51. track limiting groove; 52. limiting side groove; 53. curved arm; 54. connecting plate; 55. first connecting groove;
60. first rotating shaft; 61. second rotating shaft; 62. third rotating shaft; 63. fourth rotating shaft;
70. rotating shaft assembly; 71. bolt; 72. rotating shaft body; 73. shaft sleeve; 74. first component; 75. second component.

### DETAILED DESCRIPTION OF EMBODIMENTS

Embodiments of the present disclosure will be described in detail below, and examples of the embodiments are shown in the drawings, in which like or similar signs represent like or similar elements or elements having like or similar functions throughout the drawings. The embodiments described below with reference to the drawings are exemplary, and merely used to explain the present disclosure, but cannot be construed as limitation to the present disclosure.

In the description of the present disclosure, it should be understood that orientation or positional relationships indicated by the terms “upper”, “lower”, “longitudinal”, “top”, “bottom”, “inner”, “outer”, “axial”, “circumferential” and so on are based on orientation or positional relationships as shown in the drawings, merely for facilitating describing the present disclosure and simplifying the description, rather than indicating or implying that related devices or elements have to be in the specific orientation or configured and operated in a specific orientation, and thus they should not be construed as limiting the present disclosure.

Besides, the terms “first” and “second” are merely used for descriptive purpose, but should not be construed as indicating or implying importance in the relativity or implicitly indicating the number of a related technical feature. Thus, defining a feature with “first” or “second” may explicitly or implicitly mean that one or more such features are included. In the description of the present disclosure, “a plurality of” means two or more, unless otherwise defined explicitly.

In the present disclosure, unless otherwise specified and defined explicitly, the terms such as “mount”, “join”, “connect”, and “fix” should be construed in a broad sense, for example, a connection may be a fixed connection, a detachable connection, or an integral connection; it may be a mechanical connection, or also may be an electrical connection; it may be a direct connection, an indirect connection via an intermediary, or internal communication between two elements or interaction between two elements. For those ordinarily skilled in the art, specific meanings of the above terms in the present disclosure could be understood according to specific circumstances.

In the present disclosure, unless otherwise specified and defined explicitly, a first feature being “above” or “below” a second feature may include the first feature and the second feature being in direct contact, or the first feature and the second feature being in contact through an intermediary. The first feature being “under”, “beneath” or “below” a second feature may include a case where the first feature is directly below or obliquely below the second feature, or merely indicates that the first feature is at a horizontal height lower than that of the second feature.

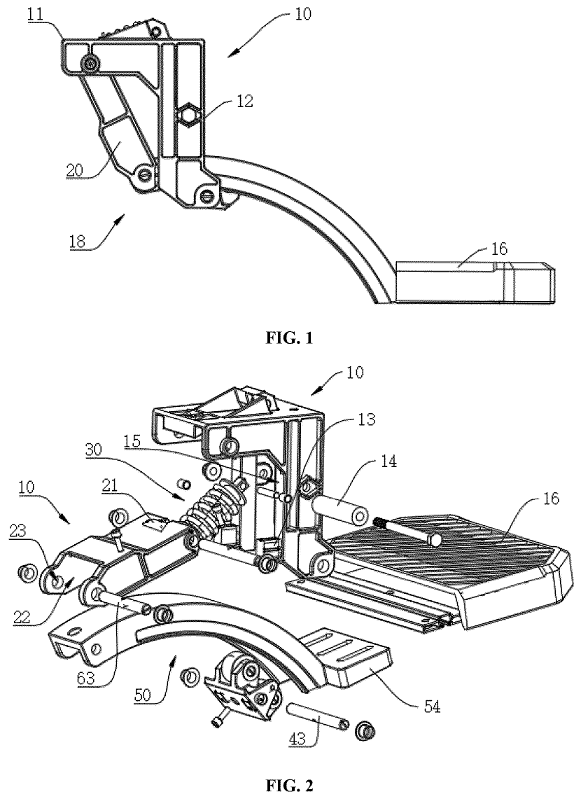

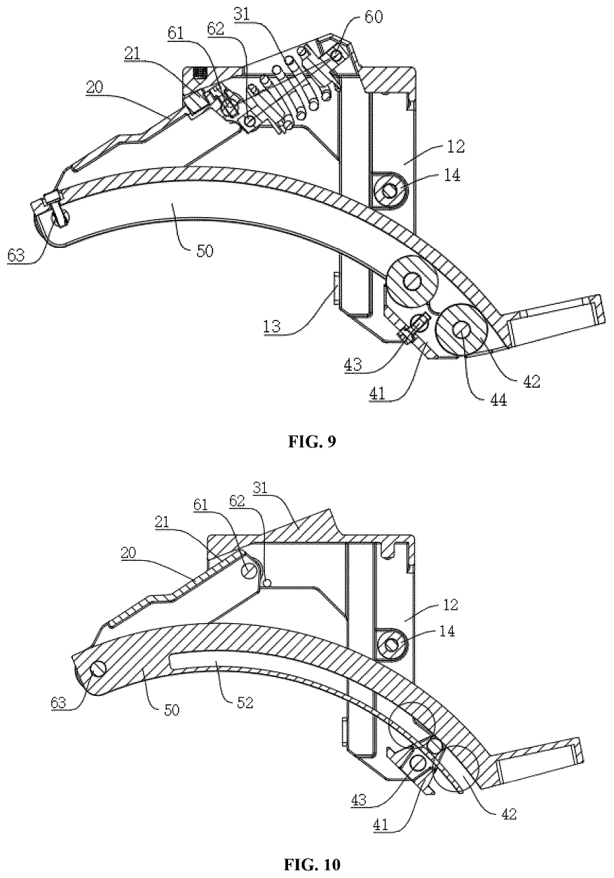

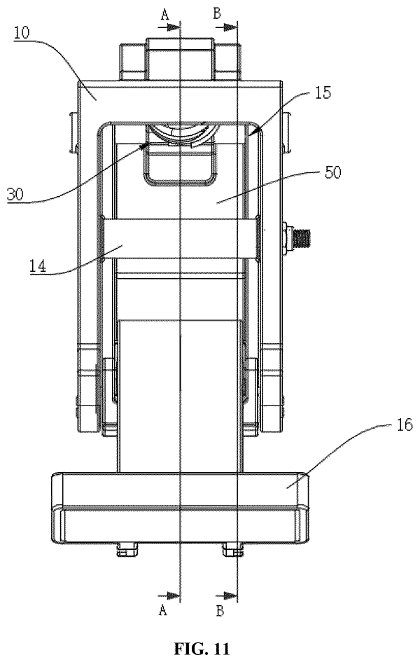

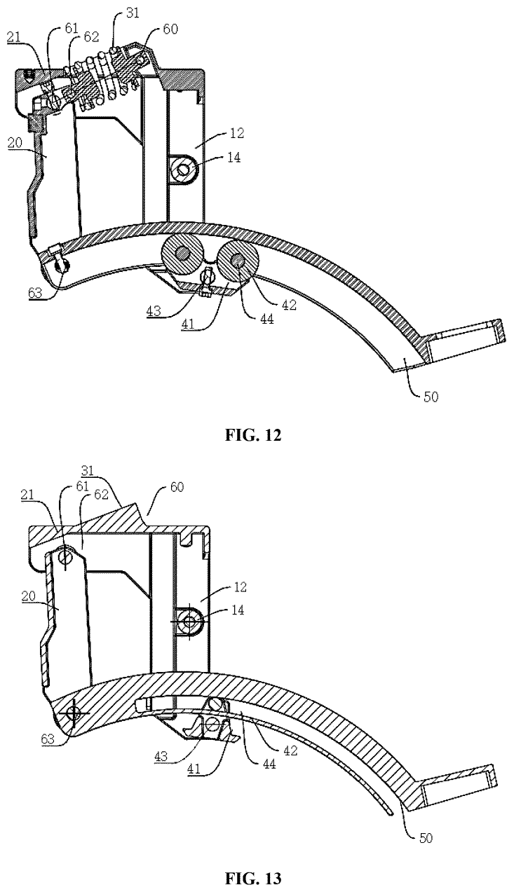

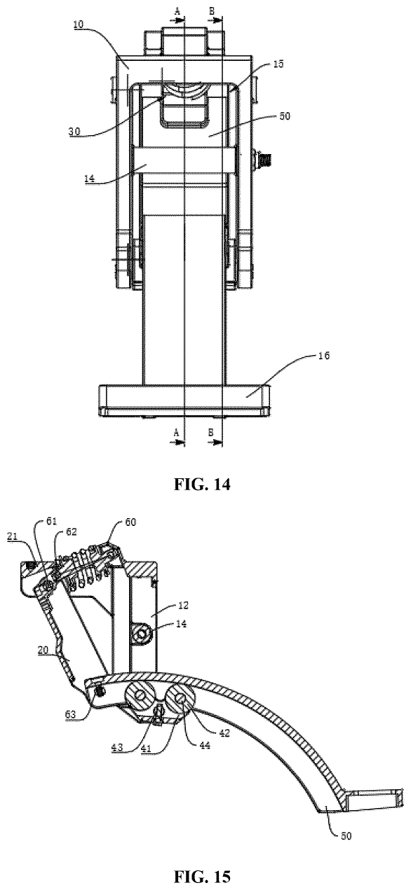

As shown in FIG. 1 to FIG. 18, a semi-automatic pedal 16 according to preferred embodiments of the present disclosure includes a fixed seat 10 configured to be connected to a vehicle body, a pedal 16 and a transmission assembly 18. The transmission assembly 18 includes an elastic driving member 30, a first transmission arm 20, a sliding member 40 and a second transmission arm 50. The fixed seat 10 includes a first fixed plate 11 and a second fixed plate 12. An upper end of the second fixed plate 12 is connected to the first fixed plate 11. The second fixed plate 12 is provided with a limiting passage 15 having an opening facing downwards. At least a part of the second transmission arm 50 passes through the limiting passage 15. The first fixed plate 11 is rotatably connected to an upper end of the elastic driving member 30 through a first rotating shaft 60. The first fixed plate 11 is rotatably connected to an upper end of the first transmission arm 20 through a second rotating shaft 61. The upper end of the first transmission arm 20 is rotatably connected to a lower end of the elastic driving member 30 through a third rotating shaft 62. A lower end of the first transmission arm 20 is rotatably connected to an upper end of the second transmission arm 50 through a fourth rotating shaft 63. A lower end of the second transmission arm 50 is connected to the pedal 16. The second transmission arm 50 is connected to a lower end of the second fixed plate 12 through the sliding member 40. The second transmission arm 50 is provided with a track limiting groove 51. The sliding member 40 is slidably mounted in the track limiting groove 51. The first rotating shaft 60, the second rotating shaft 61, the third rotating shaft 62, and the fourth rotating shaft 63 are provided in the same direction.

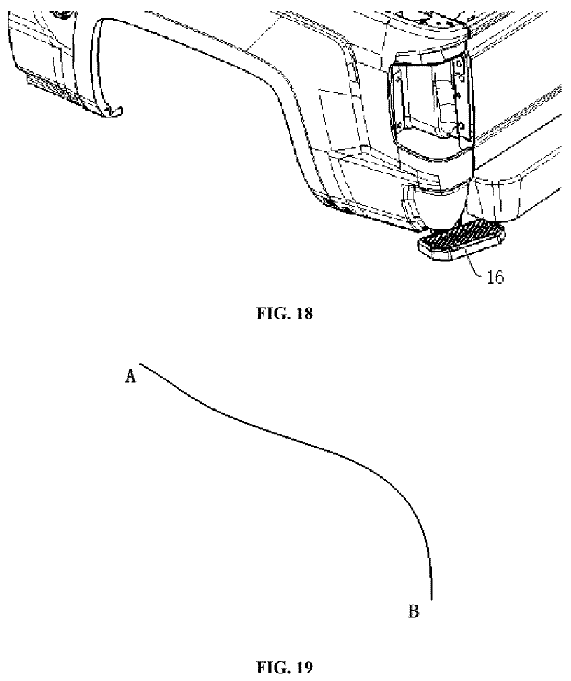

In the semi-automatic pedal 16 of the present disclosure, the fixed seat 10 is configured to be connected to a bottom portion of the vehicle body, and fix the transmission assembly 18. The pedal 16 is configured to help people to get in and out of the vehicle. The fixed seat 10 includes the first fixed plate 11 and the second fixed plate 12, where the upper end of the second fixed plate 12 is connected to the first fixed plate 11, and the lower end of the second fixed plate 12 extends downwards. The pedal 16 is located at one side of the second fixed plate 12 away from the first fixed plate 11. An accommodation cavity is defined at sides, away from the pedal 16, of the first fixed plate 11 and the second fixed plate 12. When the transmission assembly 18 is in a folded state, the transmission assembly 18 is located in the accommodation cavity. In the above, the transmission assembly 18 includes the elastic driving member 30, the first transmission arm 20, the sliding member 40 and the second transmission arm 50, where the elastic driving member 30 provides a transmission driving force for the transmission assembly 18. Specifically, the upper end of the elastic driving member 30 is connected to the first fixed plate 11 through the first rotating shaft 60, and the upper end of the elastic driving member 30 rotates relative to the first fixed plate 11; the upper end of the first transmission arm 20 is connected to the first fixed plate 11 through the second rotating shaft 61, and the upper end of the first transmission arm 20 can rotate relative to the first fixed plate 11; the upper end of the first transmission arm 20 is connected to the lower end of the elastic driving member 30 through the third rotating shaft 62, and the upper end of the first transmission arm 20 can rotate relative to the lower end of the elastic driving member 30; and the lower end of the first transmission arm 20 is rotatably connected to the upper end of the second transmission arm 50 through the fourth rotating shaft 63, and the lower end of the first transmission arm 20 can rotate relative to the upper end of the second transmission arm 50. Meanwhile, the first rotating shaft 60, the second rotating shaft 61, the third rotating shaft 62, and the fourth rotating shaft 63 are provided in the same direction. The second transmission arm 50 is connected to the second fixed plate 12 through the sliding member 40, where the second fixed plate 12 is provided with the limiting passage 15, the second transmission arm 50 is connected to the pedal 16 through the limiting passage 15, and the second transmission arm 50 is retracted or extends out through the limiting passage 15, so as to realize the folded or unfolded state. The second transmission arm 50 is provided with a track limiting groove 51, and the sliding member 40 is slidably mounted in the track limiting groove 51. By applying a downward or upward force to the pedal 16, the sliding member 40 is enabled to slide relatively in the track limiting groove 51, so as to realize that the second transmission arm 50 drives the pedal 16 to move away from or close to the second fixed plate 12, and the pedal 16 extends out to form the unfolded state or is retracted to form the folded state. When people need to get in or out of the vehicle, a downward force is applied to the pedal 16, and the second transmission arm 50 drives the pedal 16 to move downwards away from the second fixed plate 12, so that the pedal 16 is lowered to a suitable height and facilitates people in getting in or out of the vehicle, thus effectively improving the comfort for people to enter a trunk or cargo hold of a pickup truck. When the pedal 16 does not need to be used, an upward force is applied to the pedal 16, the second transmission arm 50 extends into the accommodation cavity, and the pedal 16 moves upwards towards the second fixed plate 12, as shown in FIG. 18, so that the second transmission arm 50 is hidden in the vehicle body, thus reducing or avoiding the pedal 16 from protruding out from the vehicle body to affect trafficability of the vehicle. At the same time, the pedal only needs to be mounted to an edge of the bottom portion of the vehicle body through the fixed seat 10, and can be directly mounted and connected to the original vehicle, thus reducing retrofitting costs.

In the above, it should be noted that an X direction of the vehicle is a longitudinal direction of the vehicle, that is, a forward direction of the vehicle; a Y direction of the vehicle is a transverse direction of the vehicle, that is, a width direction of the vehicle; and a Z direction of the vehicle is a vertical direction.

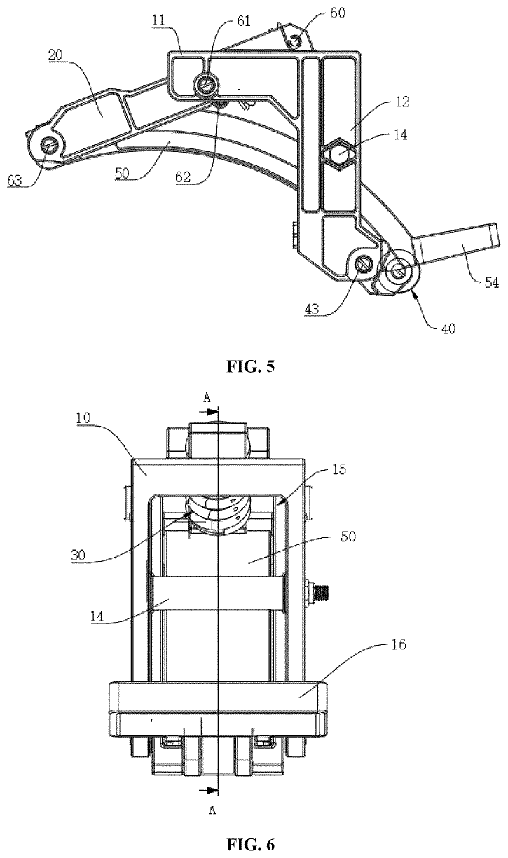

Further, as shown in FIG. 5 to FIG. 16, when the sliding member 40 is located at the lower end of the second transmission arm 50, a distance between the lower end of the second transmission arm 50 and the first fixed plate 11 is a, a distance between the lower end of the second transmission arm 50 and the second fixed plate 12 is b; and when the sliding member 40 is located at the upper end of the second transmission arm 50, a distance between the lower end of the second transmission arm 50 and the first fixed plate 11 is c, and a distance between the lower end of the second transmission arm 50 and the second fixed plate 12 is d, where a is less than c, and b is less than d. The distance between the lower end of the second transmission arm 50 and the first fixed plate 11 is a distance in the Z direction, and the distance between the lower end of the second transmission arm 50 and the second fixed plate 12 is a distance in the Y direction. When the lower end of the second transmission arm 50 is connected to the pedal 16, and the sliding member 40 is located at the lower end of the second transmission arm 50, the transmission assembly 18 is in the folded state, the distance between the lower end of the second transmission arm 50 and the second fixed plate 12 is relatively small, the distance between the lower end of the second transmission arm 50 and the first fixed plate 11 is small, facilitating it being hidden in the vehicle body. When the transmission assembly 18 is in the unfolded state, the lower end of the second transmission arm 50 moves downwards away from the second fixed plate 12, the sliding member 40 slides to the upper end of the second transmission arm 50, the distances between the lower end of the second transmission arm 50 and the first fixed plate 11 and between the lower end and the second fixed plate 12 are increased respectively, so that the pedal 16 moves downwards to an appropriate position and protrudes outwards to facilitate people in getting in or out of the vehicle.

Further, as shown in FIG. 4, the sliding member 40 includes a sliding base 41, a roller 42 and a fifth rotating shaft 43, where the roller 42 is rotatably mounted on the sliding base 41, the sliding base 41 is connected to the lower end of the second fixed plate 12 through the fifth rotating shaft 43. The roller 42 is rotatably mounted in the track limiting groove 51. The sliding base 41 is connected to the lower end of the second fixed plate 12 through the fifth rotating shaft 43, so as to realize rotational connection between the sliding base 41 and the second fixed plate 12. The sliding base 41 realizes sliding relative to the second transmission arm 50 through the roller 42. The roller 42 abuts against a groove bottom of the track limiting groove 51, so that transmission is smoother. As an embodiment therein, two rollers 42 are provided so as to improve transmission stability of the sliding base 41 and the second transmission arm 50.

As an embodiment therein, as shown in FIG. 4, the roller 42 is a bearing roller 42.

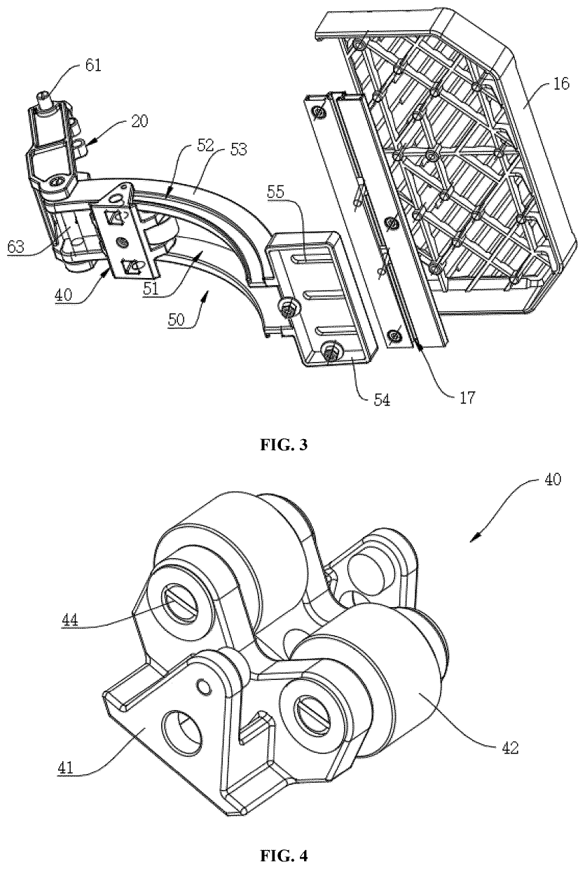

Further, as shown in FIG. 3, a side wall of the track limiting groove 51 is provided with a limiting side groove 52, the sliding member 40 includes a roller shaft 44, the roller 42 is rotationally mounted on the sliding base 41 through the roller shaft 44, and the roller shaft 44 is slidably mounted in the limiting side groove 52. The roller 42 is slidably mounted in the limiting side groove 52, so as to ensure that the roller 42 always abuts against the groove bottom of the track limiting groove 51. As an embodiment therein, two side plates of the track limiting groove 51 are each provided with the limiting side groove 52, and two ends of the roller shaft 44 are respectively connected to the limiting side grooves 52, so as to improve mounting stability of the roller 42.

As an embodiment therein, as shown in FIG. 3, extending directions of the track limiting groove 51 and the limiting side grooves 52 are the same as an extending direction of the second transmission arm 50.

Further, as shown in FIG. 2, one side of the first transmission arm 20 facing the first fixed plate 11 is connected with a first cushion pad 21, and the second fixed plate 12 is provided with a second cushion pad 13 and a third cushion pad 14, where the second cushion pad 13 is located at the lower end of the second fixed plate 12 and faces one side of the first transmission arm 20, and the third cushion pad 14 is mounted in the limiting passage 15 and located above the second transmission arm 50.

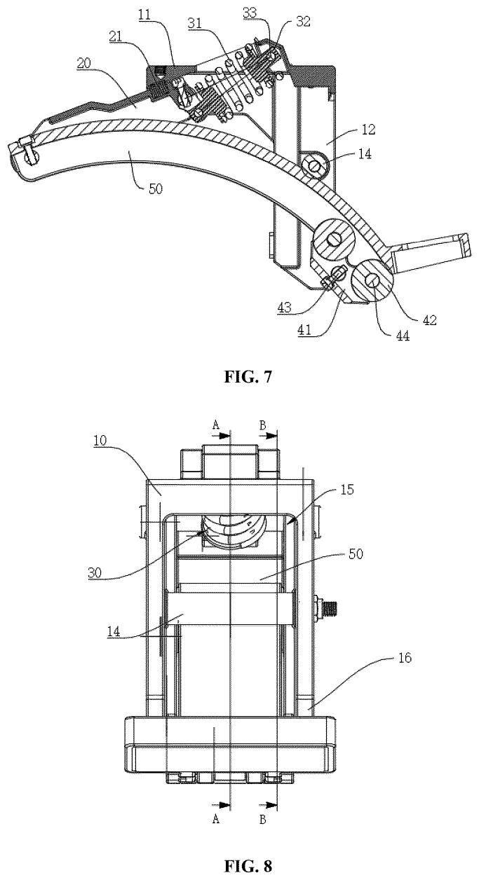

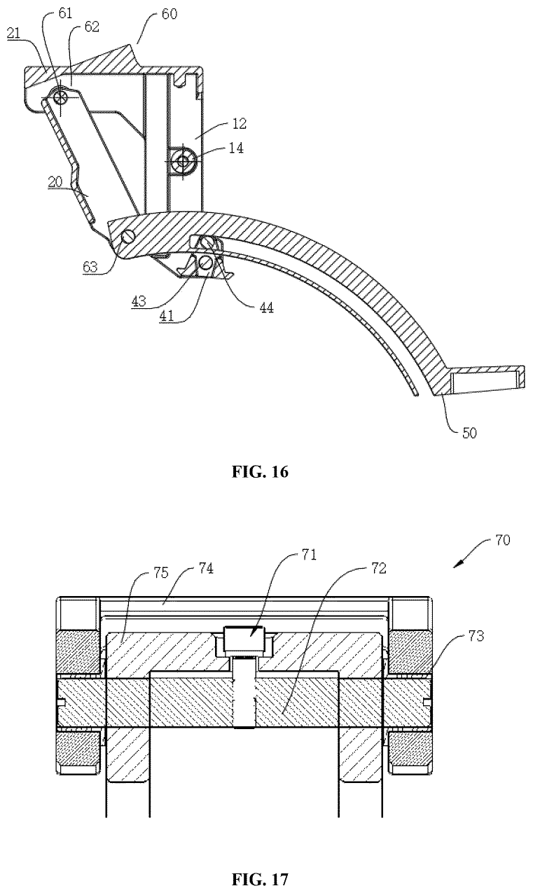

The transmission assembly 18 has the folded state and the unfolded state. When the transmission assembly 18 is in the folded state, as shown in FIG. 7, the upper end of the first transmission arm 20 abuts against the first fixed plate 11 through the first cushion pad 21, and the third cushion pad 14 abuts against the second transmission arm 50. When the transmission assembly 18 is in the unfolded state, as shown in FIG. 16, the lower end of the first transmission arm 20 abuts against the lower end of the second fixed plate 12 through the second cushion pad 13. When the transmission assembly 18 is in the folded state, a position of the first transmission arm 20 is limited and buffered by the first cushion pad 21, the second transmission arm 50 is limited and buffered by the third cushion pad 14; and when the transmission assembly is in the unfolded state, the first transmission arm 20 is limited and buffered by the second cushion pad 13. The folded state and the unfolded state are two extreme states of the transmission assembly 18, and the first cushion pad 21, the second cushion pad 13 and the third cushion pad 14 are respectively used to prevent scratch between rotating components, and reduce sound generated by impact between the rotating components. The third cushion pad 14 is fixed on the second fixed plate 12 by a screw, thus preventing the second transmission arm 50 from further moving up and down, and effectively mitigating an impact force from the unfolded state to the folded state. The first transmission arm 20 is provided with a first groove body, the first cushion pad 21 is in interference fit with the first groove body; the second fixed plate 12 is provided with a second groove body, and the second cushion pad 13 is in interference fit with the second groove body, so as to improve mounting stability of the first cushion pad 21 and the second cushion pad 13. The first cushion pad 21, the second cushion pad 13 and the third cushion pad 14 may be made from EPDM, high-density foamed polyurethane, or the like, and mounting manners are not limited to fixing by a bolt 71 and interference fitting, as long as connection between two components can be realized.

Further, as shown in FIG. 3, the second transmission arm 50 includes a curved arm 53 and a connecting plate 54. The curved arm 53 is provided with the track limiting groove 51 having an opening facing downwards. A groove bottom surface of the track limiting groove 51 at least includes a curved surface with a downward opening. The connecting plate 54 is connected to a lower end of the curved arm 53. The connecting plate 54 is connected to the pedal 16. The pedal 16 is located at one side of the second fixed plate 12 away from the first transmission arm 20. The curved arm 53 is in a smooth curved shape, so that the sliding member 40 slides more smoothly in the track limiting groove 51. The second transmission arm 50 is connected to the pedal 16 through the connecting plate 54, and the connecting plate 54 extends towards the pedal 16, so as to provide a mounting position for connection of the pedal 16. In the above, at least one end of a track of the curved arm 53 is shaped as a curved line, and a shape of the curved arm 53 matches a shape of the track limiting groove 51. Since the groove bottom surface of the track limiting groove 51 at least includes a section of curved surface with a downward opening, when at least a section of the groove bottom surface of the track limiting groove 51 is a curved surface, a track formed by the pedal 16 is a smooth curved line as shown in FIG. 19. When the transmission assembly 18 is changed from the folded state to the unfolded state, or from the unfolded state to the folded state, the pedal 16 moves along this smooth curved line as a track. In the above, when the pedal 16 is located at point A, the transmission assembly 18 is in the folded state. When a downward force is applied to the pedal 16, the pedal moves to point B along the smooth curved line as a track, and the transmission assembly 18 is in the unfolded state. The groove bottom surface of the track limiting groove 51 is set as a curved surface, so that in the folded state and in the unfolded state, a difference in a height direction and a difference in a horizontal direction of the pedal 16 are increased, that is, the pedal 16 is vertically lowered more and horizontally extends longer, thus facilitating user's stepping. Moreover, the pedal 16 moves longer between the point A and the point B when a moving track is a curved line than when the moving track is a straight line, thus effectively relieving an impact force between the components in the transmission assembly 18.

As an embodiment therein, the curved arm 53 is in an arc shape, and when the arc is a section of a circle, a radian a of the arc shape is set to be 45°<a<150°.

As an embodiment therein, the first transmission arm 20 is set with a length of 100 mm-130 mm.

Certainly, the curved arm 53 is shaped as a section of an arc shape, or the curved arm 53 is in a curved shape formed by connecting multiple sections of arc shapes, or the curved arm 53 is in a curved shape formed by connecting curved line(s) and straight line(s). That is, the groove bottom surface of the track limiting groove 15 is formed by connecting a plurality of downward-opening curved surfaces, or the groove bottom surface of the track limiting groove is formed by connecting downward-opening curved surface(s) and flat surface(s), in which two cases, the technical effects that the pedal 16 is vertically lowered more and horizontally extends longer and facilitates user's stepping can be achieved.

Further, as shown in FIG. 5, when the transmission assembly 18 is in the folded state, one end of the connecting plate 54 is connected to the lower end of the curved arm 53, and the other end of the connecting plate 54 is tilted upwards. The connecting plate 54 is horizontally connected to the pedal 16, and the connecting plate 54 is tilted upwards in the folded state, so as to reduce space occupied in the Y direction, and optimize trafficability of the vehicle body in the Y direction and in the Z direction.

As an embodiment therein, as shown in FIG. 16, when the transmission assembly 18 is in the unfolded state, the connecting plate 54 and the pedal 16 extend in the Y direction, and the connecting plate 54 and the pedal 16 are in a horizontal state, thus facilitating use of people, and improving the comfort and safety of people.

Further, as shown in FIG. 3, the connecting plate 54 is provided with a first connecting groove 55 extending in a first direction, a side of the pedal 16 facing the connecting plate 54 is provided with a second connecting groove 17 extending in a second direction, and the connecting plate 54 is connected to the pedal 16 by a connecting member passing through the first connecting groove 55 and the second connecting groove 17, where the first direction intersects with the second direction. The pedal 16 can provide a stepping region for the user to get in or out of the vehicle, and a mounting direction of the pedal 16 can be adjusted by the user by adjusting a position of the pedal 16 in the first connecting groove 55 and the second connecting groove 17 through the connecting member, thus making it easier to step and adapt to a variety of vehicle models.

As an embodiment therein, as shown in FIG. 3, the first direction and the second direction are perpendicular to each other.

As an embodiment therein, as shown in FIG. 3, the pedal 16 may be an aluminum casting or may be made from other materials. The pedal 16 is mounted with a guide rail, the second connecting groove 17 is provided in the guide rail, a screw slides in the first connecting groove 55 and the second connecting groove 17 of the guide rail, and the bolt 71 is connected to the screw so as to realize mounting and locking of the pedal 16 and the connecting plate 54, and connect the second transmission arm 50 and the pedal 16 to form an integrated component.

Further, as shown in FIG. 7, the elastic driving member 30 includes an elastic member 31 and cover plates 32. Two ends of the elastic member 31 are respectively connected to the cover plates 32. The cover plates 32 are each provided with a cover shaft hole 33. The first rotating shaft 60 is connected to the first fixed plate 11 through the cover shaft hole 33 located at the upper end of the elastic driving member 30. The third rotating shaft 62 is connected to the upper end of the first transmission arm 20 through the cover shaft hole 33 located at the lower end of the elastic driving member 30. The elastic member 31 provides a driving force for the transmission assembly 18, and the two ends of the elastic member 31 are respectively connected to the first fixed plate 11 and the first transmission arm 20 through the cover plates 32. Specifically, the first rotating shaft 60 is connected to the first fixed plate 11 through the cover shaft hole 33 located at the upper end of the elastic driving member 30. The third rotating shaft 62 is connected to the upper end of the first transmission arm 20 through the cover shaft hole 33 located at the lower end of the elastic driving member 30.

As an embodiment therein, the elastic member 31 is a spring. Spring is a common component and has a low manufacturing cost.

As an embodiment therein, an angle between the elastic member 31 and the horizontal direction is set to be 0-60°. When the angle between the elastic member 31 and the horizontal direction is 0°, an overall appearance of the fixed base 10 is flat, avoiding interference with other components during assembly. When the angle between the elastic member 31 and the horizontal direction is greater than 0° and less than or equal to 60°, space occupied by the elastic member 31 in the height direction is reduced, which helps to miniaturize the fixed base 10.

Further, as shown in FIG. 2, the lower end of the first transmission arm 20 is provided with an avoidance cavity 22 having an opening facing the second transmission arm 50, the lower end of the first transmission arm 20 is provided with a connecting hole 23, the connecting hole 23 communicates with the avoidance cavity 22, the upper end of the second transmission arm 50 is mounted in the avoidance cavity 22, and the fourth rotating shaft 63 is mounted in the connecting hole 23. The lower end of the first transmission arm 20 is provided with the avoidance cavity 22, and avoidance space is provided for rotation of the second transmission arm 50 through the avoidance cavity 22, so that the whole transmission assembly 18 has a more compact structure.

As shown in FIG. 17, the first rotating shaft 60, the second rotating shaft 61, the third rotating shaft 62 and the fourth rotating shaft are respectively configured to realize relative rotation of two components, and are existing structures. As an embodiment therein, the first rotating shaft 60, the second rotating shaft 61, the third rotating shaft 62 and the fourth rotating shaft 63 are rotating shaft assemblies 70, respectively, and relative rotational connection of a first component 74 and a second component 75 is realized through the rotating shaft assemblies 70, where the first component 74 and the second component 75 are two components rotating relative to each other in the present disclosure. In the above, the rotating shaft assemblies 70 include the bolt 71, a rotating shaft body 72 and a shaft sleeve 73. The rotating shaft body 72 is provided with a rotating shaft hole, the first component 74 is provided with a first connecting hole 23, the second component 75 is provided with a second connecting hole 23, the shaft sleeve 73 is mounted in the first connecting hole 23, and the rotating shaft body 72 is mounted in the first connecting hole 23 and the second connecting hole 23 through the shaft sleeve 73. The first component 74 is provided with a fixing hole, and the bolt 71 passes through the rotating shaft hole and the fixing hole respectively to be connected to the rotating shaft body 72, so as to prevent the rotating shaft from escaping.

An operation process of the present disclosure is as follows.

When the transmission assembly is in the folded state, as shown in FIG. 3 to FIG. 7, the first fixed plate 11 is connected to the upper end of the first transmission arm 20 and the upper end of the elastic driving member 30 respectively, the upper end of the first transmission arm 20 is connected to the lower end of the elastic driving member 30, the lower end of the first transmission arm 20 is connected to the upper end of the second transmission arm 50 through the fourth rotating shaft 63, and the lower end of the second transmission arm 50 is connected to the second fixed plate 12 through the sliding member 40, so as to form the transmission assembly 18. The second rotating shaft 61 is located at one side facing the first fixed plate 11, and the third rotating shaft 62 is located at one side facing the second fixed plate 12.

When the user wants to use the semi-automatic pedal 16, as shown in FIG. 8 to FIG. 10, a downward force is applied to the pedal 16, the transmission assembly 18 may be driven to rotate, that is, the second transmission arm 50 may rotate around the fourth rotating shaft 63, in this case, the sliding member 40 itself may rotate around the fifth rotating shaft 43, and the roller 42 inside the sliding member 40 may roll on itself and slide in the track limiting groove 51 and the limiting side groove 52 on the second transmission arm 50, so as to constrain a movement track of the second transmission arm 50. Subsequently, the first transmission arm 20 is driven to rotate around the second rotating shaft 61, in which case, the elastic member 31 may also be compressed under pressure, and the cover plate 32 may rotate around the first rotating shaft 60 and the third rotating shaft 62, respectively.

In the above movement state, as shown in FIG. 11 to FIG. 13, the transmission assembly 18 continues to move, and when the first rotating shaft 60, the third rotating shaft 62 and the second rotating shaft 61 are located on the same plane, the transmission assembly 18 is in a balanced state in this case, that is, when the downward force on the pedal 16 is withdrawn, the transmission assembly 18 can maintain this state unchanged, and in this case, the elastic member 31 is compressed to the shortest state.

In the balanced state, the transmission assembly 18 continues to move, and continues to apply a downward force to the pedal 16, the elastic driving member 30 may go over its own balance point, the elastic member 31 may move in an extension direction, and an elastic force generated may promote the first transmission arm 20 and the second transmission arm 50 to continue to rotate around the rotating shafts until the transmission assembly 18 is completely unfolded to form the unfolded state. In the unfolded state, a connection plane of the first rotating shaft 60 and the second rotating shaft 61 is located above a connection plane of the first rotating shaft 60 and the third rotating shaft 62, the elastic driving member 30 continues to provide an elastic force, and the elastic driving member 30 is in an outward-ejecting state. Under the effect of the elastic driving member 30, the fixed seat 10 is in close contact with the first transmission arm 20, and the semi-automatic pedal 16 has been fully extended out, thus providing convenience of stepping by the user.

In the above, a process from the balanced state to the unfolded state, the first transmission arm 20 has the elastic force applied by the spring driving member; when the second cushion pad 13 of the second fixed plate 12 is in contact with the first transmission arm 20, the transmission assembly 18 reaches a static state, and the second cushion pad 13 may counteract the impact force in this case, and can separate direct contact between the second fixed plate 12 and the first transmission arm 20, thus protecting a protective coating on a surface of parts.

When the semi-automatic pedal 16 is to be folded, as shown in FIG. 11 to FIG. 16, an upward pushing force needs to be applied to the pedal 16, so that it drives the first transmission arm 20, and then overcomes the elastic force generated by the elastic driving member 30, in which case, it is required to change from the unfolded state to the balanced state, and an applied external force needs to break the balanced state, so that the upward pushing force applied to the pedal 16 can be withdrawn, the whole transmission assembly 18 may move under the effect of an elongation elastic force of the spring driving member until it is completely folded and reaches the folded state.

In the above, as shown in FIG. 8 to FIG. 10, between the balanced state and the folded state, in this case, the external force acting on the pedal 16 has been withdrawn. In this case, a plane of a connecting line of the third rotating shaft 62 and the first rotating shaft 60 is below a plane of a connecting line of the first rotating shaft 60 and the second rotating shaft 61, and in this case, the spring driving member continues to extend and provides an elastic force outwards, so that the first transmission arm 20 continues to rotate until the first transmission arm 20 is in tight contact with the first fixed plate 11, finally the folded state is achieved, and retraction of the semi-automatic pedal 16 is completed.

Thus, through the transmission assembly 18, the pedal 16 of the semi-automatic pedal 16 is controlled to extend out and retract, so that the pedal 16 can be effectively hidden below the vehicle bottom or extend out of the vehicle body.

To sum up, the embodiments of the present disclosure provide a semi-automatic pedal 16. When people need to get in or out of the vehicle, a downward force is applied to the pedal 16, and the second transmission arm 50 drives the pedal 16 to move downwards away from the second fixed plate 12, so that the pedal 16 is lowered to a suitable height and facilitates people in getting in or out of the vehicle, thus effectively improving the comfort for people to enter a trunk or cargo hold of a pickup truck. When the pedal 16 does not need to be used, an upward force is applied to the pedal 16, the second transmission arm 50 extends into the accommodation cavity, and the pedal 16 moves upwards towards the second fixed plate 12, so that the second transmission arm 50 is hidden in the vehicle body, thus reducing or avoiding the pedal 16 from protruding out from the vehicle body to affect trafficability of the vehicle. At the same time, the pedal only needs to be mounted to an edge of the bottom portion of the vehicle body through the fixed seat 10, and can be directly mounted and connected to the original vehicle, thus reducing retrofitting costs.

In the present description, exemplary expressions of the above terms do not necessarily refer to the same embodiment or example. Moreover, specific features, structures, materials or characteristics described can be combined in any one or more embodiments or examples in any appropriate manner. Furthermore, those skilled in the art could integrate and combine different embodiments or examples as well as the features in different embodiments or examples described in the present description without conflict.

Although the embodiments of the present disclosure have been shown and described above, it can be understood that the above embodiments are exemplary and should not be construed as limitation to the present disclosure, and those ordinarily skilled in the art could change, modify, substitute and vary the above embodiments within the scope of the present disclosure.

1. A semi-automatic pedal, comprising: a fixed seat configured to be connected to a vehicle body, a pedal and a transmission assembly, wherein the transmission assembly comprises an elastic driving member, a first transmission arm, a sliding member and a second transmission arm, the fixed seat comprises a first fixed plate and a second fixed plate, an upper end of the second fixed plate is connected to the first fixed plate, the second fixed plate is provided with a limiting passage having an opening facing downwards, at least a part of the second transmission arm passes through the limiting passage, the first fixed plate is rotatably connected to an upper end of the elastic driving member through a first rotating shaft, the first fixed plate is rotatably connected to an upper end of the first transmission arm through a second rotating shaft, the upper end of the first transmission arm is rotatably connected to a lower end of the elastic driving member through a third rotating shaft, a lower end of the first transmission arm is rotatably connected to an upper end of the second transmission arm through a fourth rotating shaft, a lower end of the second transmission arm is connected to the pedal, the second transmission arm is connected to a lower end of the second fixed plate through the sliding member, the second transmission arm is provided with a track limiting groove, the sliding member is slidably mounted in the track limiting groove, and the first rotating shaft, the second rotating shaft, the third rotating shaft, and the fourth rotating shaft are provided in the same direction.

2. The semi-automatic pedal according to claim 1, wherein when the sliding member is located at the lower end of the second transmission arm, a distance between the lower end of the second transmission arm and the first fixed plate is a, a distance between the lower end of the second transmission arm and the second fixed plate is b; and when the sliding member is located at the upper end of the second transmission arm, a distance between the lower end of the second transmission arm and the first fixed plate is c, and a distance between the lower end of the second transmission arm and the second fixed plate is d, wherein a is less than c, and b is less than d.

3. The semi-automatic pedal according to claim 1, wherein the sliding member comprises a sliding base, a roller and a fifth rotating shaft, wherein the roller is rotatably mounted on the sliding base, the sliding base is connected to the lower end of the second fixed plate through the fifth rotating shaft, the roller is rotatably mounted in the track limiting groove.

4. The semi-automatic pedal according to claim 3, wherein a side wall of the track limiting groove is provided with a limiting side groove, the sliding member comprises a roller shaft, the roller is rotationally mounted on the sliding base through the roller shaft, and the roller shaft is slidably mounted in the limiting side groove.

5. The semi-automatic pedal according to claim 1, wherein one side of the first transmission arm facing the first fixed plate is connected with a first cushion pad, and the second fixed plate is provided with a second cushion pad and a third cushion pad, wherein the second cushion pad is located at the lower end of the second fixed plate and faces one side of the first transmission arm, and the third cushion pad is mounted in the limiting passage and located above the second transmission arm; and
the transmission assembly has a folded state and an unfolded state, wherein when the transmission assembly is in the folded state, the upper end of the first transmission arm abuts against the first fixed plate through the first cushion pad, and the third cushion pad abuts against the second transmission arm; and when the transmission assembly is in the unfolded state, the lower end of the first transmission arm abuts against the lower end of the second fixed plate through the second cushion pad.

6. The semi-automatic pedal according to claim 1, wherein the second transmission arm comprises a curved arm and a connecting plate, wherein the curved arm is provided with the track limiting groove having an opening facing downwards, a groove bottom surface of the track limiting groove at least comprises a curved surface, the connecting plate is connected to a lower end of the curved arm, the connecting plate is connected to the pedal, and the pedal is located at one side of the second fixed plate away from the first transmission arm.

7. The semi-automatic pedal according to claim 6, wherein when the transmission assembly is in the folded state, one end of the connecting plate is connected to the lower end of the curved arm, and the other end of the connecting plate is tilted upwards.

8. The semi-automatic pedal according to claim 6, wherein the connecting plate is provided with a first connecting groove extending in a first direction, a side of the pedal facing the connecting plate is provided with a second connecting groove extending in a second direction, and the connecting plate is connected to the pedal by a connecting member passing through the first connecting groove and the second connecting groove, wherein the first direction intersects with the second direction.

9. The semi-automatic pedal according to claim 1, wherein the elastic driving member comprises an elastic member and cover plates, two ends of the elastic member are respectively connected to the cover plates, the cover plates are each provided with a cover shaft hole, the first rotating shaft is connected to the first fixed plate through the cover shaft hole located at the upper end of the elastic driving member, and the third rotating shaft is connected to the upper end of the first transmission arm through the cover shaft hole located at the lower end of the elastic driving member.

10. The semi-automatic pedal according to claim 1, wherein the lower end of the first transmission arm is provided with an avoidance cavity having an opening facing the second transmission arm, the lower end of the first transmission arm is provided with a connecting hole, the connecting hole communicates with the avoidance cavity, the upper end of the second transmission arm is mounted in the avoidance cavity, and the fourth rotating shaft is mounted in the connecting hole.
